(19) United States
(12) Patent Application Publication
(10) Pub. No.: US 2009/0181253 A1
(43) Pub. Date: Jul. 16, 2009

(54) PARTICULATE INTERPENETRATING NETWORK POLYMER

(75) Inventors: Stephen Michalik, Beaver, PA (US); Kristen VanBuskirk, Aliquippa, PA (US); Paul Arch, Coraopolis, PA (US)

Correspondence Address: NOVA Chemicals Inc., Westpointe Center, 1550 Coraopolis Heights Road, Moon Township, PA, 15108, US

(73) Assignee: NOVA CHEMICALS INC., Moon Township, PA (US)

(21) Appl. No.: 12/327,051

(22) Filed: Dec. 3, 2008

Related U.S. Application Data
(60) Provisional application No. 61/021,059, filed on Jan. 15, 2008.

(51) Int. Cl. B32B 5/16

(52) U.S. Cl. 428/402

(57) ABSTRACT

A particulate interpenetrating network polymer that is composed of a polyolefin polymer and a vinyl aromatic polymer that includes residues of (meth)acrylic acid, is described. The particulate interpenetrating network polymer is formed by polymerization of a vinyl aromatic monomer composition substantially within the polyolefin polymer. The vinyl aromatic monomer composition includes vinyl aromatic monomer (e.g., styrene) and a comonomer that is composed at least in part of (meth)acrylic acid (e.g., (meth)acrylic acid and optionally butyl(meth)acrylate). The amount of (meth)acrylic acid present within the comonomer (and accordingly the vinyl aromatic polymer) is selected such that a molded article prepared from expanded particulate interpenetrating network polymer, has a volume shrinkage value of less than or equal to 5 percent, when subjected to a temperature of 100° C. for 24 hours. Also described is an expandable particulate interpenetrating network polymer that includes the particulate interpenetrating network polymer of the present invention and an expansion agent (e.g., pentane) impregnated therein.

### CROSS REFERENCE TO RELATED PATENT APPLICATION

The present non-provisional patent application is entitled to and claims, under 35 U.S.C. §119(e), the benefit of U.S. Provisional Patent Application Ser. No. 61/021,059, filed 15 Jan. 2007, which is incorporated herein by reference in its entirety.

### FIELD OF THE INVENTION

The present invention relates to a particulate interpenetrating network polymer that provides molded articles having reduced volume shrinkage. The particulate interpenetrating network polymer includes a polyolefin polymer and a vinyl aromatic polymer. The vinyl aromatic polymer is prepared from a vinyl aromatic polymer monomer composition that includes vinyl aromatic monomer, and a comonomer that includes (meth)acrylic acid. The polyolefin polymer and vinyl aromatic polymer together form the particulate interpenetrating network polymer. The (meth)acrylic acid comonomer is present in the vinyl aromatic polymer monomer composition in an amount such that a molded article, prepared from expanded particulate interpenetrating network polymer, has a volume shrinkage value of less than or equal to 5 percent, when subjected to a temperature of 100° C. for 24 hours.

### BACKGROUND OF THE INVENTION

Particulate interpenetrating network polymers are generally known. Interpenetrating network polymers are typically formed by polymerizing a monomer composition (e.g., a vinyl aromatic monomer composition comprising styrene) within a particulate polymer (e.g., particulate polyolefin material, such as polyethylene). Polymerization of the vinyl aromatic polymer (e.g., polystyrene) at least partially within the particulate polyolefin (e.g., polyethylene) results in formation of a particulate interpenetrating network polymer. Particulate interpenetrating network polymers typically provide improved physical properties, such as impact resistance, relative to comparative materials having the same polymer (or monomer) ratios, e.g., a physical mixture or blend of the separate polymers, or a copolymer formed from monomers of the polymers.

The improved physical properties provided by interpenetrating network polymers are more particularly evidenced with molded articles prepared from expanded particulate interpenetrating network polymers. Typically, the particulate interpenetrating network polymer material is rendered expandable by impregnation with an expansion agent, such as isopentane. The expandable particulate interpenetrating network polymer material, having an expansion agent impregnated therein, is typically introduced into an expander. Upon exposure to elevated temperature within the expander, the expansion agent expands (e.g., becoming at least partially volatile), thus causing the expandable particulate interpenetrating network polymer material to expand or foam. Volatile expansion agent is usually vented from the expander during the expansion process.

The expanded particulate interpenetrating network polymer, after an optional storage (or aging) period at ambient conditions, is then charged to a mold where it is exposed to elevated temperature and pressure. The abutting surfaces of the expanded interpenetrating network polymer particles fuse together, resulting in the formation of a molded article. Residual volatile expansion agent that may be present in the expanded particles, is typically vented from the mold during the molding process.

Molded articles prepared from expanded particulate interpenetrating network polymers may, in certain circumstances, be subjected to elevated temperatures (e.g., temperatures in excess of 32° C. or 38° C.) for extended periods of time. Applications in which molded articles may be exposed to elevated temperatures include, for example, vehicles, such as automobiles, trucks, water craft (e.g., boats and jet skis) and aircraft. When exposed to elevated temperatures, molded articles prepared from expanded particulate interpenetrating network polymers, such as cushions and bumpers, may undergo volumetric shrinkage. Volumetric shrinkage of molded articles prepared from expanded particulate interpenetrating network polymers typically results in a reduction in the physical properties (e.g., impact resistance) and/or aesthetic properties (e.g., deformation of an exterior overlayed sheet or film material) of the molded article.

It would be desirable to develop new particulate interpenetrating network polymer materials that provide molded articles prepared therefrom having reduced shrinkage. It would be further desirable that such newly developed particulate interpenetrating network polymer materials also provide molded articles that do not suffer from reduced physical and/or aesthetic properties.

U.S. Pat. No. 6,355,341 B1 discloses compositions that include a blend of: an alkenyl aromatic polymer (e.g., a polymer prepared from styrene and a minor amount of acrylic acid or methacrylic acid); a substantially random interpolymer (e.g., formed from ethylene and vinyl aromatic monomers); and a blowing agent. The compositions of the '341 patent may be used to prepare foams having enlarged cell size. The '341 patent defines the term “interpolymer” as “a polymer wherein at least two different monomers are polymerized to make the interpolymer . . . includ[ing] copolymers, terpolymers, etc.”

### SUMMARY OF THE INVENTION

In accordance with the present invention, there is provided a particulate interpenetrating network polymer comprising:

(a) a polyolefin polymer present in an amount of from 10 percent by weight to 80 percent by weight, based on total weight of said particulate interpenetrating network polymer; and

(b) a vinyl aromatic polymer present in an amount of from 20 percent by weight to 90 percent by weight, based on total weight of said particulate interpenetrating network polymer, said vinyl aromatic polymer, being prepared from a vinyl aromatic monomer composition comprising,
(i) a vinyl aromatic monomer present in an amount of from 70 percent by weight to 98.5 percent by weight, based on total weight of said vinyl aromatic monomer composition, and
(ii) a comonomer present in an amount of from 1.5 percent by weight to 30 percent by weight, based on total weight of said vinyl aromatic monomer composition, said comonomer comprising (meth)acrylic acid,

wherein said polyolefin polymer and said vinyl aromatic polymer together form said particulate interpenetrating network polymer, said vinyl aromatic monomer composition being polymerized substantially within said polyolefin polymer,

further wherein said comonomer comprises (meth)acrylic acid (and accordingly the vinyl aromatic monomer composition and the vinyl aromatic polymer) in an amount such that a molded article prepared from an expanded particulate interpenetrating network polymer, has a volume shrinkage value of less than or equal to 5 percent (based on the original volume of the molded article prior to heat aging), when subjected to a temperature of 100° C. for 24 hours,
said expanded particulate interpenetrating network polymer having a pre-molded density of typically 16 to 96 Kg m³ (1 to 6 pounds/ft³), more typically 32 to 80 Kg/m³ (2 to 5 pounds/ft³) and further typically 48 to 64 Kg/m³ (3 to 4 pounds/ft³), and being prepared by expansion of an expandable particulate interpenetrating network polymer, said expandable particulate interpenetrating network polymer comprising said particulate interpenetrating network polymer and an expansion agent.

As used herein and in the claims, the term “(meth)acrylic acid” and similar terms, means acrylic acid, methacrylic acid and combinations thereof. As used herein and in the claims, the term “esters of (meth)acrylic acid” and similar terms, such as “(meth)acrylate” means esters of acrylic acid (or acrylates), esters of methacrylic acid (or methacrylates) and combinations thereof.

Other than in the operating examples, or where otherwise-indicated, all numbers or expressions referring to quantities of ingredients, reaction conditions, etc. used in the specification and claims are to be understood as modified in all instances by the term “about”.

### DETAILED DESCRIPTION OF THE INVENTION

There are provided, in accordance with the present invention, certain particulate interpenetrating network polymers as summarized above, that include a polyolefin polymer. As used herein and in the claims, the term “polyolefin” and similar terms, such as “polyalkylene” and “thermoplastic polyolefin,” means polyolefin homopolymers, polyolefin copolymers, homogeneous polyolefins, heterogeneous polyolefins, and blends of two or more thereof. For purposes of illustration, examples of polyolefin copolymers include, but are not limited to, those prepared from ethylene and at least one of: one or more C₃-C₁₂ alpha-olefins, such as 1-butene, 1-hexene and/or 1-octene; vinyl acetate; vinyl chloride; (meth)acrylic acid; and esters of (meth)acrylic acid, such as C₁-C₈-(meth)acrylates.

The polyolefin of the particulate interpenetrating network polymer of the present invention may be selected from heterogeneous polyolefins, homogeneous polyolefins, or combinations thereof. The term “heterogeneous polyolefin” and similar terms means polyolefins having a relatively wide variation in: (i) molecular weight amongst individual polymer chains (i.e., a polydispersity index of greater than or equal to 3); and (ii) monomer residue distribution (in the case of copolymers) amongst individual polymer chains. The term “polydispersity index” (PDI) means the ratio of M_{w}/Mₙ, where M_{w} means weight average molecular weight, and Mₙ means number average molecular weight, each being determined by means of gel permeation chromatography (GPC) using appropriate standards, such as polyethylene standards. Heterogeneous polyolefins are typically prepared by means of Ziegler-Natta type catalysis in heterogeneous phase.

The term “homogeneous polyolefin” and similar terms means polyolefins having a relatively narrow variation in: (i) molecular weight amongst individual polymer chains (i.e., a polydispersity index of less than 3); and (ii) monomer residue distribution (in the case of copolymers) amongst individual polymer chains. As such, in contrast to heterogeneous polyolefins, homogeneous polyolefins have similar chain lengths amongst individual polymer chains, a relatively even distribution of monomer residues along polymer chain backbones, and a relatively similar distribution of monomer residues amongst individual polymer chain backbones. Homogeneous polyolefins are typically prepared by means of single-site, metallocene or constrained-geometry catalysis. The monomer residue distribution of homogeneous polyolefin copolymers may be characterized by composition distribution breadth index (CDBI) values, which are defined as the weight percent of polymer molecules having a comonomer residue content within 50 percent of the median total molar comonomer content. As such, a polyolefin homopolymer has a CDBI value of 100 percent. For example, homogenous polyethylene/alpha-olefin copolymers typically have CDBI values of greater than 60 percent or greater than 70 percent. Composition distribution breadth index values may be determined by art recognized methods, for example, temperature rising elution fractionation (TREF), as described by Wild et al, Journal of Polymer Science, Poly. Phys. Ed., Vol. 20, p. 441 (1982), or in U.S. Pat. No. 4,798,081, or in U.S. Pat. No. 5,089,321.

In an embodiment of the present invention, the polyolefin is a polyethylene. In accordance with the description provided herein with regard to the term “polyolefin,” the term “polyethylene” means polyethylene homopolymers, polyethylene copolymers, homogeneous polyethylenes, heterogeneous polyethylenes; blends of two or more such polyethylenes thereof; and blends of polyethylene with another polymer (e.g., polypropylene).

Polyethylene copolymers that may be used in the present invention typically include: at least 50 weight percent, and more typically at least 70 weight percent of ethylene monomer residues; and less than or equal to 50 weight percent, and more typically less than or equal to 30 weight percent of non-ethylene comonomer residues (e.g., vinyl acetate monomer residues). The weight percents in each case being based on total weight of monomer residues. Polyethylene copolymers may be prepared from ethylene and any monomer that is copolymerizable with ethylene. Examples of monomers that are copolymerizable with ethylene include, but are not limited to, C₃-C₁₂ alpha-olefins, such as 1-butene, 1-hexene and/or 1-octene; vinyl acetate; vinyl chloride; (meth)acrylic acid; and esters of (meth)acrylic acid.

Polyethylene blends that may be used in the present invention typically include: at least 50 percent by weight, and more typically at least 60 percent by weight of polyethylene polymer (e.g., polyethylene homopolymer and/or copolymer); and less than or equal to 50 percent by weight, and more typically less than or equal to 40 percent by weight of another polymer, that is different than the polyethylene polymer (e.g., polypropylene). The weight percents in each case being based on total polymer blend weight. Polyethylene blends may be prepared from polyethylene and any other polymer that is compatible therewith. Examples of polymers that may be blended with polyethylene include, but are not limited to, polypropylene, polybutadiene, polyisoprene, polychloroprene, chlorinated polyethylene, polyvinyl chloride, styrene-butadiene copolymers, vinyl acetate-ethylene copolymers, acrylonitrile-butadiene copolymers, vinyl chloride-vinyl acetate copolymers, and combinations thereof.

In an embodiment of the present invention, the polyethylene polymer is selected from: low density polyethylene; medium density polyethylene; high density polyethylene; a copolymer of ethylene and vinyl acetate; a copolymer of ethylene and butyl acrylate; a copolymer of ethylene and methyl methacrylate; a blend of polyethylene and polypropylene; a blend of polyethylene and a copolymer of ethylene and vinyl acetate; and a blend of polyethylene and a copolymer of ethylene and propylene.

In a particular embodiment, the polyolefin polymer is prepared from an olefin monomer composition that includes ethylene monomer, and optionally a comonomer selected from alpha-olefin monomer other than ethylene, such as C₃-C₈-alpha-olefin monomer (e.g., propylene and/or, butylene), vinyl acetate, C₁-C₂₀-(meth)acrylate, such as C₁-C₈-(meth)acrylate, and combinations thereof. Typically, ethylene monomer is present in the olefin monomer composition in an amount of at least 50 percent by weight, based on total weight of the olefin monomer composition.

In a further embodiment of the present invention, the polyolefin polymer is prepared from an olefin monomer composition that includes ethylene monomer (e.g., at least 50 percent by weight ethylene monomer, based on total weight of the olefin monomer composition), and vinyl acetate. More particularly, the polyolefin polymer is a polyethylene polymer, which is a copolymer of ethylene and vinyl acetate containing ethylene monomer residues in an amount of from 75 weight percent to 99 weight percent, and vinyl acetate monomer residues in an amount of from 1 weight percent to 25 weight percent. The weight percents in each case being based on total weight of monomer residues. In a particular embodiment, the polyolefin polymer is a polyethylene polymer, which is a copolymer of ethylene and vinyl acetate containing 95 percent by weight of ethylene monomer residues, and 5 percent by weight of vinyl acetate monomer residues, based in each case on total weight of monomer residues. As used herein and in the claims, the percent weight monomer residue values are substantially equivalent to the percent weight of corresponding monomers present within the olefin monomer composition from which the polyolefin polymer is prepared.

The polyolefin polymer is typically present in the particulate interpenetrating network polymer in an amount of less than or equal to 80 percent by weight, more typically less than or equal to 65 percent by weight, and further typically less than or equal to 50 percent by weight, based on total weight of the particulate interpenetrating network polymer. The polyolefin polymer is typically present in the particulate interpene-trating network polymer in an amount equal to or greater than 10 percent by weight, more typically equal to or greater than 15 percent weight, and further typically equal to or greater than 20 percent by weight, based on total weight of the particulate interpenetrating network polymer. The amount of polyolefin polymer present in the particulate interpenetrating network polymer of the present invention may range between any combination of these upper and lower values, inclusive of the recited values. For example, the polyolefin polymer may be present in the particulate interpenetrating network polymer in an amount of from 10 to 80 percent by weight, more typically from 15 to 65 percent by weight, and further typically from 20 to 50 percent by weight, based on total weight of the particulate interpenetrating network polymer.

The expandable particulate interpenetrating network polymer of the present invention also includes a vinyl aromatic polymer. As used herein and in the claims, the term “vinyl aromatic polymer” means vinyl aromatic homopolymers, vinyl aromatic copolymers and blends thereof.

The vinyl aromatic polymer is prepared from a vinyl aromatic monomer composition that includes: (i) a vinyl aromatic monomer; and (ii) a comonomer that comprises at least in part (meth)acrylic acid (i.e., acrylic acid, methacrylic acid or a combination of acrylic acid and methacrylic acid). The vinyl aromatic monomer (i) is typically present in an amount of from 70 to 98.5 percent by weight, more typically from 90 to 98 percent by weight, and further typically from 92 to 97 percent by weight, based on the total weight of the vinyl aromatic monomer composition. The comonomer (ii) is typically present in an amount of from 1.5 to 30 percent by weight, more typically from 2 to 10 percent by weight, and further typically from 2.5 to 7.5 percent by weight, based on the total weight of the vinyl aromatic monomer composition. In an embodiment, the vinyl aromatic monomer (i) is present in an amount of from 89 percent by weight to 98.5 percent by weight, and the comonomer (ii) is present in an amount of 1.5 percent by weight to 11 percent by weight, the percent weights in each case being based on the total weight of the vinyl aromatic monomer composition.

Vinyl aromatic monomers that may be used to prepare the vinyl aromatic polymer of the present invention include those known to the skilled artisan. In an embodiment, the vinyl aromatic monomer is selected from styrene, alpha-methylstyrene, para-methylstyrene, ethylstyrene, chlorostyrene, bromostyrene, vinyltoluene, vinylbenzene, isopropylxylene and combinations thereof.

The comonomer (ii) of the vinyl aromatic monomer composition includes at least in part (meth)acrylic acid (e.g., from 50 to 100 percent by weight of the comonomer comprising (meth)acrylic acid). The amount of (meth)acrylic acid present within the comonomer of the vinyl aromatic monomer composition (and, accordingly, the vinyl aromatic polymer) is selected such that a molded article prepared from expanded particulate interpenetrating network polymer, has a volume shrinkage value of less than or equal to 5 percent (e.g., less than or equal to 2 percent), when subjected to a temperature of 100° C. for 24 hours.

As used herein and in the claims, the “volume shrinkage values” are determined in accordance with the following description. The particulate interpenetrating network polymer of the present invention is rendered expandable by impregnation with a suitable expansion agent, which is typically isopentane, as will be discussed in further detail herein. The expansion agent (e.g., isopentane) is typically present in an amount of from 1 to 20 percent by weight (e.g., 10 to 11 percent by weight), based on total weight of the expandable particulate interpenetrating network polymer (including the weight of expansion agent). The expandable particulate interpenetrating network polymer is expanded by exposure to heat within an expander, so as to result in the formation of an expanded particulate interpenetrating network polymer having a density (i.e., a pre-molded density) of typically 16 to 96 Kg/m³ (1 to 6 pounds/ft³), more typically 32 to 80 Kg/m³ (2 to 5 pounds/ft³) and further typically 48 to 64 Kg/m³ (3 to 4 pounds/ft³). Further details concerning formation and expansion of the expandable particulate interpenetrating network polymer (and accordingly formation of the expanded particulate interpenetrating network polymer), and determination of pre-molded density values, is provided in the Examples herein under the headings of Impregnation and Expansion.

The expanded particulate interpenetrating network polymer is then stored (or aged) under ambient conditions in open containers for a period of approximately 24 hours (or 1 day). The ambient aged expanded particulate interpenetrating network polymer material is substantially free of expansion agent (e.g., typically containing residual expansion agent, if any, in an amount of less than 0.5 percent by weight, based on total weight of the expanded particulate interpenetrating network polymer). The aged expanded particulate interpenetrating network polymer is then introduced into a mold and subjected to heat and pressure, resulting in the formation of a 61 cm×61 cm×5.1 cm (24 inch×24 inch×2 inch) molded block. Test samples having dimensions of 10.2 cm×10.2 cm×5.1 cm (4 inches×4 inches×2 inches) are cut, using a band saw or heated metal wire, from the larger 61 cm×61 cm×5.1 cm molded blocks. The test samples are exposed to a temperature of 100° C. for 24 hours in an electric oven, after which dimensions of the test samples are measured and compared with the pre-heated/aged dimensions to determine percent volume shrinkage values, using the following equation:

100×{(initial volume)−(heat aged volume)}/(initial volume)

In particular, the width, length and height dimensions of the test samples are measured manually prior to and after heat aging, and the values thereof are used to calculate volume values of the respective test samples. Accordingly, the volume shrinkage values are percent volume shrinkage values that are based on the original or initial volume of the molded test samples prior to exposure to a temperature of 100° C. for 24 hours (i.e., prior to heat aging). Further details concerning molding of the expanded particulate interpenetrating network polymers, and preparation and testing of the test samples are provided in the Examples herein under the heading of Molding. Volume shrinkage values of lower magnitude (i.e., less than or equal to 5 percent) are desirable, while volume shrinkage values of greater magnitude (i.e., greater than 5 percent) are undesirable.

The (meth)acrylic acid monomer, more particularly, is typically present in the comonomer, of the vinyl aromatic polymer monomer composition, in an amount of less than or equal to 100 percent by weight, more typically less than or equal to 95 percent by weight, further typically less than or equal to 90 percent by weight, and still further typically less than or equal to 80 percent by weight, based on the total weight of the comonomer. The (meth)acrylic acid monomer is also typically present in the comonomer, of the vinyl aromatic polymer monomer composition, in an amount of at least 50 percent by weight, more typically at least 60 percent by weight, further typically at least 65 percent by weight, and still further typically in an amount of at least 70 percent by weight, based on total weight of the comonomer. The amount of (meth)acrylic acid monomer present in the comonomer, of the vinyl aromatic polymer monomer composition, may range between any combination of these upper and lower amounts, inclusive of the recited values. For example, the (meth)acrylic acid monomer may be present in the comonomer, of the vinyl aromatic polymer monomer composition, in an amount of from 50 to 100 percent by weight, or from 60 to 95 percent by weight, or from 65 to 90 percent by weight, or from 70 to 80 percent by weight, based on the total weight of comonomer.

In an embodiment, the comonomer, of the vinyl aromatic monomer composition, includes (meth)acrylic acid, and a further comonomer. When the comonomer includes both (meth)acrylic acid and a further comonomer, the (meth)acrylic acid monomer is typically present in an amount of less than 100 percent by weight, based on comonomer weight, and accordingly the balance thereof is composed of the further comonomer. For example, the further comonomer may be present in an amount of from 1 to 50 percent by weight, or from 5 to 40 percent by weight, or from 10 to 35 percent by weight, or from 20 to 30 percent by weight; while the (meth)acrylic acid is present in an amount of from 50 to 99 percent by weight, or from 60 to 95 percent by weight, or from 65 to 90 percent by weight, or from 70 to 80 percent by weight, in each case, the percent weights being based on total weight of comonomer and further comonomer.

Further comonomers that may be together polymerized with (meth)acrylic acid and the vinyl aromatic monomer(s) to form the vinyl aromatic polymer of the present invention, include those known to the skilled artisan. Examples of further comonomers include, but are not limited to, (meth)acrylates, such as C₁-C₂₀- or C₁-C₈-(meth)acrylates (e.g., butyl acrylate, ethyl acrylate, 2-ethylhexyl acrylate, methyl methacrylate, ethyl methacrylate, butyl methacrylate, and 2-ethylhexyl methacrylate); acrylonitrile; vinyl acetate; dialkyl maleates (e.g., dimethyl maleate and diethyl maleate); and maleic anhydride. The further comonomer may also be selected from multi-ethylenically unsaturated monomers, such as dienes (e.g., 1,3-butadiene); di-(meth)acrylates of alkyleneglycols having one or more alkyleneglycol repeat units (e.g., ethyleneglycol di-(meth)-acrylate, diethyleneglycol di-(meth)acrylate, and poly(ethyleneglycol) di-(meth)acrylate having 3 or more ethyleneglycol repeat units, such as 3 to 100 repeat units); trimethylolpropane di- and tri-(meth)acrylate; pentaery-thritol di-, tri- and tetra-(meth)acrylate; and divinyl benzene. Multi-ethylenically unsaturated monomers are typically present in the vinyl aromatic polymer monomer composition in amounts of less than or equal to 5 percent by weight, and more typically less than or equal to 3 percent by weight, (e.g., from 0.5 to 1.5 or 2 percent by weight) based on total weight of the vinyl aromatic polymer monomer composition.

In an embodiment, the comonomer, of the vinyl aromatic monomer composition includes: at least 50 percent by weight of (meth)acrylic acid, based on total weight of comonomer; and optionally a further comonomer selected from at least one C₁-C₈-(meth)acrylate (e.g., butyl(meth)acrylate). The (meth)acrylic acid and C₁-C₈-(meth)acrylate (as the further comonomer) may be together present in amounts selected from those percent weight ranges and values recited previously herein. In a particular embodiment, the comonomer, of the vinyl aromatic monomer composition, consists of (meth)acrylic acid, and in particular methacrylic acid, alone and in the absence of any further comonomer(s).

On the basis of the vinyl aromatic monomer composition (and accordingly the vinyl aromatic polymer), the (meth)acrylic acid monomer may be present in an amount of less than or equal to 30 percent by weight, or less than or equal to 15 percent by weight, or less than or equal to 10 percent by weight, or less than or equal to 7.5 percent by weight, or less than or equal to 5 percent by weight, or less than or equal to 3.75 percent by weight, based on the total weight of the vinyl aromatic monomer composition. The (meth)acrylic acid monomer is also typically present in the vinyl aromatic monomer composition, in an amount of at least 1.5 percent by weight, more typically at least 2 percent by weight, and further typically at least 2.5 percent by weight, based on total weight of the vinyl aromatic monomer composition. The amount of (meth)acrylic acid monomer present in the vinyl aromatic monomer composition, may range between any combination of these upper and lower amounts, inclusive of the recited values. For example, the (meth)acrylic acid monomer may be present in the vinyl aromatic monomer composition in an amount of from 1.5 to 30 percent by weight, or from 1.5 to 15 percent by weight, or from 2 to 10 percent by weight, or from 2 to 7.5 percent by weight, or from 2.5 to 5 percent by weight, or from 2.5 to 3.75 percent by weight, based on the total weight of the vinyl aromatic monomer composition (and, accordingly, the total weight of the vinyl aromatic polymer). While the comonomer of the vinyl aromatic monomer composition may include both (meth)acrylic acid and a further comonomer (e.g., butyl methacrylate), the (meth)acrylic acid is typically present in an amount of at least (i.e., not less than) 1.5 percent by weight, based on the total weight of the vinyl aromatic monomer composition.

The vinyl aromatic polymer, in an embodiment, is prepared from a vinyl aromatic monomer composition that includes: (i) styrene as the vinyl aromatic monomer; and (ii) a comonomer comprising, (meth)acrylic acid, and at least one C₁-C₂₀-(meth)acrylate, such as at least one C₁-C₈-(meth)acrylate (e.g., butyl (meth)acrylate). In a particular embodiment, the vinyl aromatic polymer is prepared from a vinyl aromatic monomer composition that includes: (i) styrene as the vinyl aromatic monomer; and (ii) a comonomer that consists of (meth)acrylic acid (e.g., 96 percent by weight styrene, and 4 percent by weight methacrylic acid, based on total weight of the vinyl aromatic monomer composition).

The vinyl aromatic polymer is typically present in the particulate interpenetrating network polymer in an amount of less than or equal to 90 percent by weight, more typically less than or equal to 85 percent by weight, and further typically less than or equal to 80 percent by weight, based on total weight of the particulate interpenetrating network polymer. The vinyl aromatic polymer is typically present in the particulate interpenetrating network polymer in an amount equal to or greater than 20 percent by weight, more typically equal to or greater than 35 percent weight, and further typically equal to or greater than 50 percent by weight, based on total weight of the particulate interpenetrating network polymer. The amount of vinyl aromatic polymer present in the particulate interpenetrating network polymer of the present invention may range between any combination of these upper and lower values, inclusive of the recited values. For example, the vinyl aromatic polymer may be present in the particulate interpenetrating network polymer in an amount of from 20 to 90 percent by weight, more typically from 35 to 85 percent by weight, and further typically from 50 to 80 percent by weight, based on total weight of the particulate interpenetrating network polymer.

The polyolefin polymer (e.g., a copolymer of ethylene and vinyl acetate) and the vinyl aromatic polymer (e.g., a copolymer of styrene, (meth)acrylic acid and optionally butyl(meth)acrylate) together form the particulate interpenetrating network polymer of the expandable particulate interpenetrating network polymer of the present invention. Typically, the interpenetrating network polymer is prepared by polymerizing the vinyl aromatic polymer monomer composition substantially within previously formed/polymerized polyolefin particles. In general, polyolefin particles are infused or impregnated with the vinyl aromatic polymer monomer composition and one or more initiators, such as peroxide initiators. The vinyl aromatic polymer monomer composition is then polymerized. Based on the evidence at hand, and without intending to be bound by any theory, it is believed that polymerization of the vinyl aromatic polymer monomer composition occurs substantially within the polyolefin particles.

In an embodiment of the present invention, the expandable particulate interpenetrating network polymer is prepared by a process comprising: (a) providing the polyolefin polymer in the form of a particulate polyolefin polymer; and (b) polymerizing the vinyl aromatic polymer monomer composition substantially within the particulate polyolefin polymer.

Formation of the particulate interpenetrating network polymer may be conducted under aqueous or non-aqueous conditions (e.g., in the presence of an organic medium). Typically, formation of the particulate interpenetrating network polymer is conducted under aqueous conditions.

When conducted under aqueous conditions, the polyolefin particles are typically first suspended in a combination of water (e.g., deionized water) and suspension agents. Numerous suspension agents that are known to the skilled artisan may be employed. Classes of suspension agents that may be used to form the interpenetrating network polymer of the present invention, include, but are not limited to: water soluble high molecular weight materials (e.g., polyvinyl alcohol, methyl cellulose, hydroxyl ethyl cellulose, and polyvinylpyrrilodone); slightly or marginally water soluble inorganic materials (e.g., calcium phosphate, magnesium pyrophosphate, and calcium carbonate); and sulfonates, such as sodium dodecylbenzene sulfonate. In an embodiment, a combination of tricalcium phosphate and sodium dodecylbenzene sulfonate is used together as suspension agents in the preparation of the particulate interpenetrating network polymer.

The suspension agent may be present in an amount so as to affect suspension of the polyolefin particles within the aqueous medium. Typically, the suspension agent is present in an amount of from 0.01 to 5 percent by weight, and more typically from 1 to 3 percent by weight, based on the total weight of the water and suspension agent(s).

The polyolefin particles are generally added, with agitation, to a previously formed water and suspension agent composition. Alternatively, the polyolefin particles, water and suspension agent may be concurrently mixed together. The amount of water present, relative to the amount of polyolefin particles may vary widely. Enough water is present for purposes of effectively suspending the polyolefin particles, and allowing for the addition, infusion and polymerization of the vinyl aromatic polymer monomer composition. Typically, the weight ratio of water to polyolefin particles is from 0.7:1 to 5:1, and more typically from 3:1 to 5:1.

The weight ratio of water to particulate polymer material may change during the process of forming the particulate interpenetrating network polymer. For example, the weight ratio of water to polyolefin particles may initially be 5:1, and with the introduction and polymerization of the vinyl aromatic polymer monomer composition over time, the weight ratio of water to the forming/formed particulate interpenetrating network polymer may be effectively and correspondingly reduced (e.g., to 1:1).

The vinyl aromatic polymer monomer composition and initiators are typically next added to the aqueous suspension of particulate polyolefin. The initiator may be added pre-mixed with the vinyl aromatic polymer monomer composition, concurrently therewith, and/or subsequently thereto. If added separately from the vinyl aromatic polymer monomer composition, the initiators may be added alone or dissolved in an organic solvent, such as toluene or 1,2-dichloropropane, as is known to the skilled artisan. Typically, the initiator is pre-mixed with (e.g., dissolved into) the vinyl aromatic polymer monomer composition, and the mixture thereof is added to the aqueous suspension of polyolefin particles.

One or more initiators suitable for polymerizing the vinyl aromatic polymer monomer composition may be used. Examples of suitable initiators include, but are not limited to: organic peroxides, such as benzoyl peroxide, lauroyl peroxide, t-butyl perbenzoate, and t-butyl peroxypivalate; and azo compounds, such as azobisisobutylonitrile and azobisdimethyl-valeronitrile.

Polymerization of the vinyl aromatic polymer monomer composition may also be conducted in the presence of chain transfer agents, which serve to control the molecular weight of the resulting vinyl aromatic polymer. Examples of chain transfer agents that may be used include, but are not limited to: C₂₋₁₅ alkyl mercaptans, such as n-dodecyl mercaptan, t-dodecyl mercaptan, t-butyl mercaptan, and n-butyl mercaptan; and alpha methyl styrene dimer.

The initiator is generally present in an amount at least sufficient to polymerize substantially all of the monomers of the vinyl aromatic polymer monomer composition. Typically, the initiator is present in an amount of from 0.05 to 2 percent by weight, and more typically from 0.1 to 1 percent by weight, based on the total weight of vinyl aromatic polymer monomer composition and initiator.

Polymerization of the vinyl aromatic polymer monomer composition within the polyolefin particles generally involves the introduction of heat into the reaction mixture. For example, the contents of the reactor may be heated to temperatures of from 60° C. to 120° C. for a period of at least one hour (e.g., 8 to 20 hours) in a closed vessel (or reactor) under an inert atmosphere (e.g., a nitrogen sweep), in accordance with art-recognized procedures. Upon completion of the polymerization, work-up procedures may include the introduction of one or more washing agents (e.g., inorganic acids), and separation of the particulate interpenetrating network polymer from the aqueous reaction medium (e.g., by means of centrifuging), in accordance with art-recognized methods.

The particulate polyolefin may be crosslinked in an embodiment of the present invention. Crosslinking of the particulate polyolefin polymer may be achieved during polymerization and formation of the polyolefin particles, and/or during polymerization of the vinyl aromatic polymer monomer composition within the polyolefin particles. Crosslinking of the particulate polyolefin polymer during formation thereof, may be achieved by the use of multi-functional initiators and/or multi-ethylenically unsaturated monomers, in accordance with art-recognized methods and materials.

In an embodiment, the particulate polyolefin polymer is crosslinked concurrently with the polymerization of the vinyl aromatic polymer monomer composition within the polyolefin particles. Typically, when performed concurrently with the polymerization of the vinyl aromatic polymer monomer composition, crosslinking of the polyolefin particles is achieved by means of cross-linking agents selected from certain organic peroxide materials. Examples of suitable crosslinking agents include, but are not limited to: di-t-butyl-peroxide, t-butyl-cumylperoxide, dicumyl-peroxide, α,α-bis-(t-butlyperoxy)-p-diisopropylbenzene, 2,5,-dimethyl-2,5-di-(t-butylperoxy)-hexyne-3,2,5-dimethyl-2,5-di-(benzoylperoxy)-hexane, t-butyl-peroxyisopropyl-carbonate; multi-functional organic peroxide materials, such as polyether poly(t-butyl peroxycarbonate), commercially available under the tradename LUPEROX JWEB50; and combinations thereof.

The crosslinking agents may be introduced as part of the vinyl aromatic polymer monomer composition, and/or separately from the vinyl aromatic polymer monomer composition (e.g., prior to, concurrently with, and/or subsequently thereto). Typically, the crosslinking agents are mixed with (e.g., dissolved into/with) the vinyl aromatic polymer monomer composition. The crosslinking agents are generally present in an amount of from 0.1 to 2 percent by weight, and typically from 0.5 to 1 percent by weight, based on the weight of polyolefin particles.

The particulate interpenetrating network polymer of the present invention may have a wide range of particle sizes and shapes. Typically, the particulate interpenetrating network polymer has an average particle size (as determined along the longest particle dimension) of from 0.2 to 2.0 mm, more typically from 0.8 to 1.5 mm, and further typically from 1.0 to 1.2 mm. The particulate interpenetrating network polymer may have shapes selected from spherical shapes, oblong shapes, rod-like shapes, irregular shapes and combinations thereof. More typically, the particulate interpenetrating network polymer has shapes selected from spherical shapes and/or oblong shapes. The particulate interpenetrating network polymer may have an aspect ratio of from 1:1 to 4:1 (e.g., from 1:1 to 2:1).

The particulate interpenetrating network polymer of the present invention may be impregnated with an expansion agent, thus resulting in the formation of an expandable particulate interpenetrating network polymer. The expandable particulate interpenetrating network polymer comprises the particulate interpenetrating network polymer of the present invention, and the expansion agent impregnated therein. Upon exposure to heat (e.g., within an expander apparatus), the expandable particulate interpenetrating network polymer expands, resulting in the formation of an expanded particulate interpenetrating network polymer. The expanded particulate interpenetrating network polymer may then be introduced into a mold where it is exposed to elevated temperature and pressure, thus resulting in the formation of a molded article.

At one or more points throughout the formation of the particulate interpenetrating network polymer, the expansion agent may be introduced therein, so as to form the expandable particulate interpenetrating network polymer. For example, the expansion agent may be introduced into the particulate interpenetrating network polymer: concurrently with polymerization of the vinyl aromatic polymer monomer composition; before crosslinking of the polyethylene particles is undertaken; after completion of the polymerization and crosslinking steps, and prior to the work-up step; and/or after the work-up step. The impregnation process may be performed in the same vessel in which the vinyl aromatic monomer polymerization is performed, and/or a separate vessel.

Typically, after work-up of the particulate interpenetrating network polymer (e.g., by the addition of washing agents, and separation from the aqueous reaction medium), the expansion agent is introduced into the particulate interpenetrating network polymer so as to form the expandable particulate interpenetrating network polymer. The expansion agent may be selected from aliphatic hydrocarbon, cycloaliphatic hydrocarbon, halogenated hydrocarbon and combinations thereof. Halogenated hydrocarbons from which the expansion agent may be selected include, but are not limited to, methyl chloride, ethyl chloride, methylene chloride, trichlorofluoromethane, dichlorofluoromethane, dichlorodifluoromethane, chlorodifluoromethane and/or dichlorotetrafluoroethane.

The halogenated hydrocarbon expansion agents may also be selected from or include one or more hydrofluorocarbons (HFC's). Examples of hydrofluorocarbons from which the expansion agent may be selected include, but are not limited to, methyl fluoride, difluoromethane, perfluoromethane, ethyl fluoride, 1,1-difluoroethane, 1,1,1-trifluoroethane, 1,1,2,2-tetrafluoroethane, 1,1,1,2-tetrafluoroethane, pentafluoroethane, perfluoroethane, 2,2-difluoropropane, 1,1,1-trifluoropropane, 1,1,1,3,3-pentafluoropropane, 1-fluorobutane, nanafluorocyclopentane, perfluoro-2-dimethylbutane, 1-fluorohexane, perfluoro-2,3-dimethylbutane, penta-fluoro-1,2,-dimethylcyclobutane, perfluorohexane, perfluoroisohexane, perfluorocylohexane, perfluoroheptane, perfluoroethylcyclohexane, perfluoro-1,3-dimethyl cyclohexane, perfluorooctane, fluorobenzene, 1,2-difluoorobenzene, 1,4-difluorobenzene, 1,3-difluoorobenzene, 1,3,5-trifluorobenzene, 1,2,4,5-tetrafluorobenzene, 1,2,3,5-tetrafluorobenzene, 1,2,3,4-tetrafluorobenzene, pentafluorobenzene, hexafluorobenzene, and 1-fluoro-3-(trifluoromethyl)benzene, and combinations of two or more thereof.

Aliphatic hydrocarbons from which the expansion agent may be selected include, for example, C₃-C₁₀-linear or branched alkanes, such as propane, butane, pentane, hexane, heptane, octane, nonane and decane. Typically, the aliphatic hydrocarbons, and in particular alkanes, from which the expansion agent may be selected have from 3 to 6 carbon atoms (e.g., propane, butane, pentane and/or hexane).

In an embodiment, the expansion agent is selected from propane, butane, pentane, hexane, cyclobutane, cyclopentane, methyl chloride, ethyl chloride, methylene chloride, trichlorofluoromethane, dichlorofluoromethane, dichlorodifluoromethane, chlorodifluoromethane, dichlorotetrafluoroethane and combinations thereof. In a further embodiment, the expansion agent is selected from n-pentane, iso-pentane, neopentane, cyclopentane and combinations thereof.

The expansion agent is typically present in the expandable particulate interpenetrating network polymer in an amount so as to provide sufficient expansion thereof when exposed to elevated temperature. For example, the expansion agent may be present in the expandable particulate interpenetrating network polymer in an amount of from 1 or 1.5 percent by weight to 20 percent by weight, typically from 1.5 percent by weight to 15 percent by weight, and more typically from 3 percent by weight to 12 percent by weight, based on the total weight of the expandable particulate interpenetrating network polymer (including the weight of the expansion agent, and inclusive of the recited values).

The expansion agent is typically introduced into the particulate interpenetrating network polymer under conditions of elevated pressure and temperature. The expansion agent may be introduced into the particulate interpenetrating network polymer in the presence or absence of a liquid suspending medium (e.g., water and/or organic solvent). For example, the particulate interpenetrating network polymer may be dispersed in the expansion agent alone, in the absence of a separate liquid suspending medium (e.g., in the absence of water), and exposed to elevated temperature and pressure.

When the particulate interpenetrating network polymer is impregnated with the expansion agent in the absence of a liquid suspending medium, a dry (or anhydrous) impregnation process may be employed. For example, the blowing agent may be introduced into a fluidized bed of the particulate interpenetrating network polymer (optionally formed within a rotating vessel), under conditions of elevated temperature (e.g., from greater than 25° C. to 70° C., or 50° C. to 60° C.).

Typically, the expansion agent is impregnated into the particulate interpenetrating network polymer in the presence of a liquid medium, and in particular in the presence of water under aqueous conditions. In particular, a suspension of particulate interpenetrating network polymer material in water and suspension agent is formed in a closed vessel. The suspension agent may be selected from those classes and examples recited previously herein with regard to formation of the particulate interpenetrating network polymer. The expansion agent is then introduced into the vessel with agitation, under an inert atmosphere (e.g., a nitrogen sweep). The temperature of the contents of the vessel is elevated (e.g., from 40° C. to 120° C.), and held for a period of time sufficient to result in infusion (or impregnation) of the expansion agent into the particulate interpenetrating network polymer (e.g., from 4 to 8 hours). The particulate interpenetrating network polymer impregnated with expansion agent (i.e., the expandable particulate interpenetrating network polymer) is then separated from the aqueous impregnation medium (e.g., by centrifuging).

The expandable particulate interpenetrating network polymer may optionally further include plasticizers, such as toluene, ethylbenzene and/or limonene. A particularly preferred plasticizer is limonene. While not intending to be bound by any theory, and based on the evidence presently at hand, it is believed that the limonene material, in addition or alternatively to acting at least to some extent as a plasticizer, may also act as an expansion agent within the expandable particulate interpenetrating network polymer. The limonene material may be selected from d-limonene, l-limonene, d/l-limonene or combinations thereof. In an embodiment, the limonene material is selected from d-limonene. The limonene material is typically present in an amount of from 0.1 to 5 percent by weight, and more typically from 0.1 to 1 percent by weight, based on the total weight of expandable particulate interpenetrating network polymer (including the weight of limonene).

The limonene material may be introduced into the particulate interpenetrating network polymer prior to, concurrently with, or subsequent to the introduction/impregnation of the expansion agent. The limonene material is usually introduced into the particulate interpenetrating network polymer concurrently with the expansion agent. For example, limonene and the expansion agent (e.g., isopentane) may be previously mixed together, and then together introduced into the particulate interpenetrating network polymer during the impregnation process, as described previously herein.

The particulate interpenetrating network polymer of the present invention may optionally include additives. Examples of additives include, but are not limited to: colorants (e.g., dyes and/or pigments); ultraviolet light absorbers; antioxidants; antistatic agents; fire retardants; fillers (e.g., clays); and nucleating agents, typically in the form of waxes (e.g., polyolefin waxes, such as polyethylene waxes). Additives may be present in the particulate interpenetrating network polymer in functionally sufficient amounts, e.g., in amounts independently from 0.1 percent by weight to 10 percent by weight, based on the total weight of the expandable particulate interpenetrating network polymer. The additives may be introduced at any point during formation of the particulate interpenetrating network polymer, or any component thereof. For example, at least some of the additives may be introduced into the polyolefin polymer during its polymerization, and/or after polymerization by melt blending (e.g., extrusion). Alternatively, at least some of the additives may be introduced during polymerization of the vinyl aromatic polymer monomer composition. Further alternatively, at least some of the additives may be introduced after formation of the particulate interpenetrating network polymer and prior to impregnation thereof with expansion agent, and/or concurrently with the impregnation process.

Expandable particulate interpenetrating network polymers, prepared from the particulate interpenetrating network polymers of the present invention, may be used to prepare molded articles comprising expanded particulate interpenetrating network polymers. Generally, the expandable particulate interpenetrating network polymer material is introduced into an expander, and exposed to elevated temperature (e.g., by passing steam through the expander). Upon exposure to elevated temperatures, the expansion agent causes the particulate interpenetrating network polymer material to expand. After an optional storage or aging period, the expanded interpenetrating network polymer material is introduced into a mold where it is exposed to elevated temperature and pressure. Abutting portions of the surfaces of the expanded interpenetrating network polymer material fuse together, and residual expansion agent, if any, is vented from the mold. The expansion agent may be captured from the expander and mold, isolated and reused or pyrolyzed, or it may be allowed to vent to the atmosphere. The molded article is then removed from the mold, and may be used as is, or subjected to post-molding operations, such as cutting, sanding, and shaping.

Examples of molded articles that may be prepared from the expanded particulate interpenetrating network polymers include, but are not limited to: containers, such as shipping containers and food containers; cushion or impact elements used in packaging assemblies; floatation devices; and cores of architectural panels (e.g., doors, walls, dividers and bulkheads) and recreational articles, such as surf boards. For purposes of illustration, a packaging assembly may include a box, such as a cardboard box, having cushion elements, fabricated from the expandable particulate interpenetrating network polymers of the present invention, retained therein. The cushion elements may be dimensioned to receive a portion of a ware (e.g., a flat screen TV) therein, thereby protecting the ware from impacts during shipping that would otherwise result in damage to the ware.

The present invention is more particularly described in the following examples, which are intended to be illustrative only, since numerous modifications and variations therein will be apparent to those skilled in the art. Unless otherwise specified, all parts and all percentages are by weight.

### EXAMPLES

### Example A

A comparative particulate interpenetrating network polymer was prepared in accordance with the following description.

| | |
|---|---|
| Material | Amount |

Charge 1

| | | |
|---|---|---|
| Deionized water | 199.2 | Kg |
| Tricalcium phosphate | 4.5 | Kg |
| Dodecylbenzene | 69.2 | g |

Charge 2

| | | |
|---|---|---|
| PE resin particles⁽¹⁾ | 39.5 | Kg |

Charge 3

| | | |
|---|---|---|
| Styrene | 87.7 | Kg |
| Butyl acrylate | 4.1 | Kg |
| Dicumylperoxide | 309.7 | g |
| Benzoylperoxide | 150 | g |
| Tert-butyl perbenzoate | 15.4 | g |

Charge 4

| Material | Comment |
|---|---|
| Hydrochloric acid⁽²⁾ | To a pH of 1.8. |

⁽¹⁾PETROTHENE NA 480-177 low density polyethylene/vinyl acetate copolymer (95.5 percent by weight ethylene, and 4.5 percent by weight vinyl acetate) resin particles obtained commercially from Equistar Chemicals, LP having: a Melt Index of 0.3 g/10 minutes; density of 0.923 g/cm³; and a Vicat softening point of 42.8° C. (109° F.).
⁽²⁾10.3-11.5 molar hydrochloric acid.

Charge 1 was added to an empty 454.6 liter (100 gallon) stainless steel reactor having a temperature controllable jacket, a motor driven impeller, a nitrogen sweep, and at least one feed port. While under a nitrogen sweep and with constant stirring provided by the impeller turning at 86 revolutions per minute, the reactor contents were raised to a temperature of 85° C.

Charge 2 was then added to the contents of the reactor with constant stirring.

Charge 3 was added drop-wise to the reactor over a period of 4.4 hours, with constant stirring (provided by the impeller turning at 86 revolutions per minute), under a nitrogen sweep, and while maintaining the contents of the reactor at a temperature of 85° C. Upon completing the addition of Charge 3, the contents of the reactor were raised to a temperature of 143° C. over a period of 153 minutes, followed by a hold at 143° C. for 2.5 hours, with constant stirring and nitrogen sweep.

After completion of the 2.5 hour hold at 143° C., the contents of the reactor were cooled to ambient temperature (of approximately 25° C.), and Charge 4 was added until the reactor contents had a pH value of 1.8. Typically, approximately 9 to 11 kilograms (20 to 25 pounds) of Charge 4 are added to achieve a pH value of 1.8.

The contents of the reactor were then transferred to and dewatered by spinning in a centrifuge. The centrifuge dried particulate interpenetrating network polymer material (having a water content of less than 1 percent by weight)(³) was retrieved from the centrifuge and then screened to remove particles having: an average diameter of less than 0.869 mm; and an average particle size of greater than 2.449 mm. The dried and screened comparative interpenetrating network polymer

particles were used to prepare comparative expandable particulate interpenetrating network polymers as described further herein.

### Example B

A particulate interpenetrating network polymer according to the present invention was prepared in accordance with the description provided for Example A, but with the following differences. The butyl acrylate of Charge 3 of Example A, was replaced in the present Example B with 4.1 Kg of methacrylic acid. After completing the addition of Charge 4, the contents of the reactor were then transferred to and dewatered by spinning in a centrifuge. The centrifuge dried particulate interpenetrating network material of Example B was retrieved from the centrifuge, and found to have a water content of 2.2 percent by weight⁽³⁾, and as such required further drying. The centrifuge dried particulate interpenetrating network material was introduced into a continuous fluidizer at a rate of 25 Kg/hour (55 pounds/hour), while air having a temperature of 80° C. was passed vertically upward through the continuous fluidizer and the particulate polymer material (at a rate sufficient to fluidize the particulate polymer material therein). The centrifuge dried particulate interpenetrating network material had a residence time in the continuous fluidized bed of approximately 15 minutes. The fluidized bed dried particulate interpenetrating network polymer material was found to have a water content of less than 1 percent by weight. ⁽³⁾ The water content was determined by subjecting the centrifuge dried particulate interpenetrating network polymer material to a temperature of 120° C. for a period of 20 minutes, and comparing the initial and heat treated weights of the centrifuge dried particulate interpenetrating network polymer material.

The centrifuge and fluidized bed dried particulate interpenetrating network material was then screened to remove particles having: an average diameter of less than 0.869 mm; and an average particle size of greater than 2.449 mm. The dried and screened interpenetrating network polymer material according to the invention were used to prepare expandable particulate interpenetrating network polymers according to the present invention as described further herein.

The particulate interpenetrating network polymer materials of Examples A and B were each separately impregnated with expansion agent in accordance with the following description.

### Impregnation

CALSOFT F90 sodium dodecyl benzene sulfonate (obtained commercially from Pilot Chemical Corporation) was added in an amount of 5 grams to a 94.6 liter stainless steel vessel having a temperature controllable jacket, a motor driven impeller, a nitrogen blanket, and at least one feed port, containing 42.4 kilograms of deionized water. With constant stirring at ambient temperature, 38.6 kilograms of particulate interpenetrating network polymer (Example A or B) was added to the vessel. D-limonene (obtained commercially from Florida Chemical Company and having a purity of 95%) in an amount of 0.14 kilograms, and 5.0 kilograms of isopentane were introduced sequentially into the closed vessel. With constant stirring (at 200 rpm), and under a nitrogen blanket, the temperature of the vessel contents was raised to a value of 70° C. over a period of 60 minutes, followed by a hold at 70° C. for 1.5 hours. The impregnated particulate interpenetrating network polymer material was removed from the vessel and dewatered in a centrifuge. Physical properties of the impregnated particulate interpenetrating network polymer materials are summarized in Table 1 further herein.

TABLE 1

| | Initial Total | Unexpanded |
|---|---|---|
| Impregnated | Volatile Content⁽⁴⁾ | Density⁽⁵⁾ |
| Example | (% by weight) | (Kg/m³) |
| A | 10.2 | 640 |
| B | 10.6 | 640 |

⁽⁴⁾The initial total volatile content (ITVC) was determined by measuring the weight loss of 3 separate samples of impregnated particulate interpenetrating network polymer material (each sample having a weight of approximately 2 grams) after exposure to a temperature of 150° C. for 30 minutes in an open container. The values shown in Table 1 are, in each case, averages of the three samples tested.
⁽⁵⁾The density of the unexpanded impregnated particulate interpenetrating network polymer material was determined by measuring the weight associated with a known volume (approximately 250 ml) of unexpanded impregnated particulate interpenetrating network polymer material. The unexpanded impregnated particulate interpenetrating network polymer material was added to a graduated vessel, which was manually shaken to settle the unexpanded particulate material, the volume was recorded, and the weight of the unexpanded particulate material measured. For purposes of conversion and reference, 1 pound/ft³ (pcf) equals 16.0 Kg/m³.

### Expansion

The impregnated particulate interpenetrating network polymer material of Example A was expanded in a TRI 502 continuous steam expander under the following conditions: 94.2° C., 0.28 Kg/cm² steam feed pressure, 204 Kg/hour bead feed rate (201.5° F., 4 psi steam feed pressure, 450 lbs/hour bead feed rate). The expanded interpenetrating network polymer material of Example A had a density of 56 Kg/m³ (3.5 pounds/ft³).

The impregnated particulate interpenetrating network polymer material of Example B was expanded in a TRI 502 continuous steam expander under the following conditions: 100° C., 0.28 Kg/cm² steam feed pressure, 204 Kg/hour bead feed rate (212.5° F, 4 psi steam feed pressure, 450 lbs/hr bead feed rate). The expanded interpenetrating network polymer material of Example A had a density of 60.8 Kg/m³ (3.8 pounds/ft³).

The densities of the expanded interpenetrating network polymer materials were determined by measuring the weight associated with a known volume (approximately 250 ml) of expanded particulate interpenetrating network polymer material. The expanded particulate interpenetrating network polymer material was added to a graduated vessel, which was manually shaken to settle the expanded particulate material, the volume was recorded, and the weight of the expanded particulate material measured. For purposes of conversion and reference, 1 pound/ft³ (pcf) equals 16.0 Kg/m³.

### Molding

Prior to molding, the expanded particulate interpenetrating network polymer material of Examples A and B were each stored (or aged) at ambient conditions (e.g., 25° C. to 27° C., and atmospheric pressure) in open containers for a period of 1 day prior to performance of the molding operations.

The expanded particulate interpenetrating network polymer material of Example A was molded into a 61 cm×61 cm×5.1 cm (24 inch×24 inch×2 inch) block in a Kohler General KG 606 steam molding press under the following conditions: Cross Steam 1:10 seconds; Moving Plate: 3 seconds; Autoclave: 1.5 seconds; Cooling: 45 seconds; Steam Pressure: 1.8 Kg/cm² (25 psi).

The expanded particulate interpenetrating network polymer material of Example B was molded into a 61 cm×61 cm×5.1 cm (24 inch×24 inch×2 inch) block in a Kohler General KG 606 steam molding press under the following conditions: Cross Steam 1:60 seconds; Moving Plate: 15 seconds; Autoclave: 15 seconds; Cooling: 180 seconds; Steam Pressure: 1.8 Kg/cm² (25 psi). The molded blocks were exposed to ambient room conditions for 24 hours prior to being cut into test samples, as described in the following paragraph.

Test samples having dimensions of 10.2 cm×10.2 cm×5.1 cm (4 inches×4 inches×2 inches) were cut, using a band saw, from the larger 61 cm×61 cm×5.1 cm molded blocks. The test samples were cut in such a way that the side surfaces thereof (i.e., having a height of 5.1 cm) had not been in contact with, and the upper and lower surfaces thereof (i.e., having dimensions of 10.2×10.2 cm) had been in contact with an interior surface of the Kohler General KG 606 steam molding press.

Volume shrinkage values of the test samples were determined and are summarized in the following Table 2.

TABLE 2

| | Example A | Example B |
|---|---|---|
| % Volume Shrinkage Value⁽⁶⁾ | 18.9% | 1.6% |

⁽⁶⁾A single test sample for each of Example A and Example B was placed on a metal tray and exposed to 100° C. for 24 hours in an electric convection oven. The test samples were removed from the oven and allowed to cool to room temperature. Dimensions of the test samples were measured before and after heat aging in the oven, and the percent volume shrinkage value was determined using the following equation: 100 × {(initial volume) − (heat aged volume)}/(initial volume)

In further evaluations, test samples corresponding to Examples A and B were found to have substantially similar physical properties, such as compressive strength (ASTM D3763), flexural strain at break (ASTM C203), tear strength (ASTM D3575) and tensile strength (ASTM D3575). Test samples corresponding to Example B were, however, found to have reduced puncture strength (determined in accordance with ASTM D3763) relative to test samples corresponding to Example A. The term “ASTM” means American Society for Testing and Materials, and together with the alphanumeric thereafter refers to the test method employed to determine the recited physical property.

Based on the volume shrinkage results summarized in Table 2, particulate interpenetrating network polymers according to the present invention (e.g., as represented by Example B) provide substantially and desirably reduced percent volume shrinkage values. In addition, particulate interpenetrating network polymers according to the present invention (e.g., as represented by Example B) were found to have substantially similar physical properties, aside from puncture strength, relative to comparative particulate interpenetrating network polymers (e.g., as represented by Example A).

The present invention has been described with reference to specific details of particular embodiments thereof. It is not intended that such details be regarded as limitations upon the scope of the invention except insofar as and to the extent that they are included in the accompanying claims.

What is claimed is:

1. A particulate interpenetrating network polymer comprising:
(a) a polyolefin polymer present in an amount of from 10 percent by weight to 80 percent by weight, based on total weight of said particulate interpenetrating network polymer; and
(b) a vinyl aromatic polymer present in an amount of from 20 percent by weight to 90 percent by weight, based on total weight of said particulate interpenetrating network polymer, said vinyl aromatic polymer, being prepared from a vinyl aromatic monomer composition comprising,
(i) a vinyl aromatic monomer present in an amount of from 70 percent by weight to 98.5 percent by weight, based on total weight of said vinyl aromatic monomer composition, and
(ii) a comonomer present in an amount of from 1.5 percent by weight to 30 percent by weight, based on total weight of said vinyl aromatic monomer composition, said comonomer comprising (meth)acrylic acid,
wherein said polyolefin polymer and said vinyl aromatic polymer together form said particulate interpenetrating network polymer, said vinyl aromatic monomer composition being polymerized substantially within said polyolefin polymer,
further wherein said comonomer comprises (meth)acrylic acid in an amount such that a molded article prepared from an expanded particulate interpenetrating network polymer, has a volume shrinkage value of less than or equal to 5 percent, when subjected to a temperature of 100° C. for 24 hours,
said expanded particulate interpenetrating network polymer having a pre-molded density of 16 to 96 Kg/m³, and being prepared by expansion of an expandable particulate interpenetrating network polymer, said expandable particulate interpenetrating network polymer comprising said particulate interpenetrating network polymer and an expansion agent.

2. The particulate interpenetrating network polymer of claim 1 wherein said comonomer, of said vinyl aromatic monomer composition, comprises at least 50 percent by weight of (meth)acrylic acid, based on total weight of said comonomer.

3. The particulate interpenetrating network polymer of claim 2 wherein said comonomer, of said vinyl aromatic monomer composition, further comprises a further comonomer selected from the group consisting of at least one C₁-C₈-(meth)acrylate.

4. The particulate interpenetrating network polymer of claim 1 wherein said comonomer, of said vinyl aromatic monomer composition, is present in an amount of from 1.5 percent by weight to 11 percent by weight, based on total weight of said vinyl aromatic monomer composition.

5. The particulate interpenetrating network polymer of claim 4 wherein said comonomer, of said vinyl aromatic monomer composition, comprises,
at least 50 percent by weight of (meth)acrylic acid, based on total weight of comonomer, and
optionally a further comonomer selected from the group consisting of at least one C₁-C₈-(meth)acrylate.

6. The particulate interpenetrating network polymer of claim 5 wherein said further comonomer is butyl(meth)acrylate.

7. The particulate interpenetrating network polymer of claim 4 wherein said comonomer, of said vinyl aromatic monomer composition, consists of methacrylic acid.

8. The particulate interpenetrating network polymer of claim 1 wherein said vinyl aromatic monomer is selected from the group consisting of styrene, alpha-methylstyrene, p-methylstyrene ethylstyrene, chlorostyrene, bromostyrene, vinyltoluene, vinylbenzene, isopropylxylene and combinations thereof.

9. The particulate interpenetrating network polymer of claim 1 wherein said vinyl aromatic monomer is styrene, and said comonomer consists of (meth)acrylic acid.

10. The particulate interpenetrating network polymer of claim 1 further comprising said expansion agent, said particulate interpenetrating network polymer being said expandable particulate interpenetrating network polymer.

11. The particulate interpenetrating network polymer of claim 10 wherein said expansion agent is selected from the group consisting of aliphatic hydrocarbon, cycloaliphatic hydrocarbon, halogenated hydrocarbon and combinations thereof.

12. The particulate interpenetrating network polymer of claim 10 wherein said expansion agent is selected from the group consisting of propane, butane, hexane, cyclobutane, cyclopentane, methyl chloride, ethyl chloride, methylene chloride, trichlorofluoromethane, dichlorofluoromethane, dichlorodifluoromethane, chlorodifluoromethane, dichlorotetrafluoroethane and combinations thereof.

13. The particulate interpenetrating network polymer of claim 12 wherein said expansion agent is selected from the group consisting of n-pentane, iso-pentane, neopentane, cyclopentane and combinations thereof.

14. The particulate interpenetrating network polymer of claim 1 wherein said polyolefin polymer is prepared from an olefin monomer composition comprising ethylene monomer, and optionally a comonomer selected from the group consisting of C₃-C₈-alpha-olefin monomer, vinyl acetate, C₁-C₈-(meth)acrylate and combinations thereof.

15. The particulate interpenetrating network polymer of claim 14 wherein ethylene monomer is present in said olefin monomer composition in an amount of at least 50 percent by weight, based on total weight of said olefin monomer composition.

16. The particulate interpenetrating network polymer of claim 14 wherein said olefin monomer composition comprises ethylene monomer and vinyl acetate.

17. The particulate interpenetrating network polymer of claim 1 wherein said polyolefin polymer is crosslinked with a crosslinking agent.

18. The particulate interpenetrating network polymer of claim 17 wherein said crosslinking agent is selected from the group consisting of di-t-butyl-peroxide, t-butyl-cumylperoxide, dicumyl-peroxide, α,α-bis-(t-butlyperoxy)-p-diisopropylbenzene, 2,5,-dimethyl-2,5-di-(t-butylperoxy)-hexyne-3,2,5-dimethyl-2,5-di-(benzoylperoxy)-hexane, t-butyl-peroxyisopropyl-carbonate, polyether poly(t-butyl peroxycarbonate) and combinations thereof.

19. The particulate interpenetrating network polymer of claim 10 wherein said expandable particulate interpenetrating network polymer further comprises from 0.1 to 5 percent by weight of limonene, based on total weight of said expandable particulate interpenetrating network polymer.

20. The particulate interpenetrating network polymer of claim 1 wherein said volume shrinkage value is less than or equal to 2 percent.

21. The particulate interpenetrating network polymer of claim 1 wherein said pre-molded density of said expanded particulate interpenetrating network polymer is 48 to 64 Kg m³.

22. The particulate interpenetrating network polymer of claim 1 wherein said particulate interpenetrating network polymer is prepared by a process comprising:
(a) providing said polyolefin polymer in the form of a particulate polyolefin polymer; and
(b) polymerizing said vinyl aromatic monomer composition substantially within said particulate polyolefin polymer.
